(19) United States
(12) Patent Application Publication
(10) Pub. No.: US 2025/0238506 A1
(43) Pub. Date: Jul. 24, 2025

(54) SYSTEM AND METHOD OF MANAGING SECURITY IN A MULTI-CLOUD ENVIRONMENT

(71) Applicant: INNOVACCER INC., San Francicso, CA (US)

(72) Inventors: Rohit RANJAN, Greater Noida West (IN); Vedang JOSHI, Ujjain (IN); Shivam KEJRIWAL, Samastipur (IN); Aneesh SHARMA, Greater Noida West (IN)

(21) Appl. No.: 18/600,355

(22) Filed: Mar. 8, 2024

(30) Foreign Application Priority Data
Jan. 22, 2024 (IN) 202411004372

(51) Int. Cl. G06F 21/56; G06F 16/901; G06F 16/904

(52) U.S. Cl. CPC G06F 21/56; G06F 16/9024; G06F 16/904

(57) ABSTRACT

Described herein is a system and method for performing data management in a multi-cloud environment. The system includes a computing unit communicably connected to a central controller, comprising an input component adapted to present an input query, and an output component adapted to elicit a response from the central controller. The central controller includes a central repository adapted to receive multi-cloud environment resource datasets. The central controller includes processing modules, each comprising programming instructions and configured to perform a predetermined activity. Each processing module includes a data ingesting module, an app controller module and a security controller module. A user presents an input query on an interface configured onto a computing unit. The central controller processes the input query with a processing module to collect and identify a complete data set collected by detecting, capturing and recognizing tasks and/or resources accessed by each user and application, and resource.

### CROSS REFERENCE TO RELATED APPLICATION

This application claims benefit of India application No. 202411004372 filed Jan. 22, 2024, the entire disclosure of which is incorporated herein by reference.

### TECHNICAL FIELD

The present subject matter in general relates to cloud computing and cybersecurity. In particular, the present subject matter relates to a system and a method for managing security, identity, and access control in a multi-cloud environment.

### BACKGROUND

The advent of cloud computing has revolutionized the way organizations manage data and deploy applications. With its ability to offer flexibility, scalability, and cost-efficiency, cloud-based infrastructures are increasingly being adopted by businesses across industries. As cloud adoption continues to soar, multi-cloud environments are adopted, where data and applications are distributed across multiple cloud service providers such as MICROSOFT AZURE®, GOOGLE® Cloud Platform (GCP), AMAZON® Web Services (AWS), and others. Multi-cloud environments are becoming increasingly popular among organizations across industries due to their flexibility, scalability, and cost-efficiency.

While multi-cloud environments offer numerous benefits, they also present unique security concerns that need to be addressed. Organizations must ensure robust protection against unauthorized access, data breaches, and potential vulnerabilities. The diverse array of cloud services and platforms increases the complexity of managing security measures across different providers.

Traditional security solutions designed for single-cloud environments may fall short in addressing the intricacies of multi-cloud security. Conventional identity and access management (IAM) solutions have been instrumental in managing user identities and controlling access to resources within a single-cloud setup. However, the dynamic and distributed nature of multi-cloud environments demands a more sophisticated and adaptable approach to IAM.

Existing IAM solutions often lack the ability to seamlessly integrate and manage identities and access across diverse cloud platforms. Organizations are faced with the challenge of ensuring consistent IAM policies, provisioning, and access control mechanisms across the spectrum of cloud providers and third-party tools. The lack of a unified framework for identity and access management across disparate sources hampers operational efficiency, increases the risk of security breaches, and impedes compliance efforts.

To address these challenges, various solutions have been proposed in the art. For example, some solutions involve using a Single sign-on (SSO) system to manage identity and access. However, such solutions may not be effective in managing security across all cloud resources, as some resources may not support SSO or may require additional authentication measures.

Other solutions involve using a central controller to manage security in a multi-cloud environment. However, most IAM solutions available in the public domain are designed for specific cloud providers and lack the flexibility to work across different cloud environments. This limitation makes it difficult for organizations to manage user identities and access rights across multiple cloud providers. Therefore, such solutions may not be effective in collecting and visualizing identity and access management data for each user of the multi-cloud environment.

Furthermore, as cloud infrastructures become more intricate, monitoring and auditing tasks become increasingly arduous. Organizations struggle to gain real-time visibility into user activities, resource usage, and potential security threats across multiple clouds. Further managing asset inventory at a single place for cloud providers and SAAS tools is another challenge.

Accordingly, an unaddressed need exists in the industry to address the aforementioned deficiencies and inadequacies.

### SUMMARY

In one aspect of the present subject matter, a system for performing data management in a multi-cloud environment is disclosed. The system includes a computing unit communicably connected to a central controller, comprises an input component adapted to present at least one input query based at least in part on related to resource management of one or more of a plurality of users and/or applications of the multi-cloud environment. The computing unit further includes an output module adapted to elicit at least one response from said central controller to the presented input query. The central controller includes a central repository adapted to receive one or more resource datasets pertaining to users and/or application and/or event of the multi-cloud environment, from one or more data sources, such as, one or more cloud servers of the application databases, user information, access rights, user access history, resource usage history, application interconnection, application resource access, and the like. In some embodiments, of the current disclosure, this is leveraged as a generic resource model which is flexible enough to accommodate any data format and provides context for the central controller to perform queries. The central controller uses generic resource model at the backend. The system further includes a plurality of processing modules, each comprising a set of programming instructions generally based on one or more deep learning model and configured to perform a predetermined activity. The plurality of processing modules includes a data ingesting module adapted to receive a resource data-set from the plurality of cloud servers and/or store in a central repository. The plurality of processing modules further includes an app controller module adapted to integrate one or more applications within the central controller and to facilitate seamless access and querying the resource data-sets stored within the central repository. The app controller module is further adapted to store an application dataset pertaining to tasks, results and insights of one or more applications within the central repository. The plurality of processing modules further includes a security controller module adapted to detect, capture and recognize the tasks and/or data accessed by each application and/or user and store in the form of a security data-set within the central repository. In operation, a user presents at least one input query related to data of one or more of the pluralities of the users and/or applications of the multi-cloud environment, on an application interface, configured onto a computing unit. At least one input query is shared with the central controller which processes the input query using one or more processing modules to collect and identify a complete data set comprising at least the security data-set collected by detecting, capturing and recognizing tasks and/or resources accessed by each of the plurality of users and/or applications and/or resources of the multi-cloud environment.

Preferably, the at least one query includes questions related to but not limited to user activity and/or usage history, resource access and any other security/access related information of the users in the multi-cloud environment. In some embodiments, the at least one query may be used to fetch a history of a user and/or resource (such as for example, Example—metadata of a cloud resource on a given day in history) in a multi-cloud environment.

In a preferred embodiment, the data management module includes a resource manager module for accessing and/or querying the resource data-sets received by the data-ingesting module.

In a preferred embodiment, the data management module includes an application manager module for accessing and/or querying the application data-sets related to one or more applications managed by the app controller module.

In yet another embodiment, the data management module includes a security manager module for accessing and/or querying the security data-sets security controller module.

In a preferred embodiment, the plurality of data-sources include one or more cloud servers selected from one or more of but not limited to Azure, GCP, AWS, and the like and/or one or more SaaS.

Particularly, the application interface may be adapted to send the input query to the central controller via one or more first communication mediums.

Preferably, the first communication medium may be selected in the form of an application programming interface (API) connecting the application interface with the central controller.

In another aspect of the present invention, the present invention provides a method for managing data within a multi-cloud environment. The method includes the step of presenting one or more queries to the central controller on an interface on a computing unit. The method further includes the step of processing the input query in accordance with one or more processing modules for collecting and identifying a complete data-set for each of the users/applications of the multi-cloud environment including at least a security data identified by detecting, capturing and recognizing each of the tasks and/or data accessed by each of the plurality of users and/or applications and/or resources of the multi-cloud environment. The method further includes the step of graphically visualizing the identified data-set, in accordance with the input query, onto an output component of the application interface.

In an embodiment, the method may include ingestion of an information data-set from a plurality of data sources and subsequently storing within a central repository, the plurality of data-sources including at least one cloud server.

Further, the method may include integrating one or more applications within in the central controller

Furthermore, the plurality of processing modules may include a data ingesting module adapted to receive a resource data-set from a plurality of data sources and subsequently store within a central repository.

In an embodiment, the plurality of processing modules may include an app controller module adapted to integrate one or more applications within the central controller. The app controller module is further adapted to store an application data-set pertaining to tasks, results and insights of one or more applications, within the central repository.

In an embodiment, the plurality of processing modules includes a security controller module adapted to detect, capture and recognize the tasks and/or data accessed by each of the one or more applications and/or users, and store in the form of a security data-set within the central repository

The details of one or more implementations are set forth in the accompanying drawings and the description below. Other aspects, features and advantages of the subject matter disclosed herein will be apparent from the description, the drawings, and the claims.

### BRIEF DESCRIPTION OF THE DRAWINGS

FIG. 1 illustrates a high-level block diagram of a multi-cloud management system in accordance with an exemplary embodiment of the present disclosure.

FIG. 2 illustrates a high-level block diagram for a central controller in accordance with an exemplary embodiment of the present disclosure.

FIG. 3 illustrates a block diagram for a security controller in accordance with an exemplary embodiment of the present disclosure.

FIG. 4 illustrates an exemplary microservice based architecture for a multi-cloud management system in accordance with an exemplary embodiment of the present disclosure.

FIG. 5 illustrates a flowchart depicting a method for managing data in a multi-cloud environment in accordance with an exemplary clinical use case of the present disclosure.

### DETAILED DESCRIPTION

As required, a schematic, exemplary-only embodiment of the present application is disclosed herein; however, it is to be understood that the disclosed embodiment is merely exemplary of the present disclosure, which may be embodied in various and/or alternative forms. Specific structural and functional details disclosed herein are not to be interpreted as limiting, but merely as a basis for the claims and as a representative basis for teaching one skilled in the art to variously employ the present disclosure in virtually any appropriately detailed structure.

Aspects, advantages and/or other features of the exemplary embodiment of the disclosure will become apparent in view of the following detailed description, which discloses various non-limiting embodiments of the invention. In describing exemplary embodiments, specific terminology is employed for the sake of clarity. However, the embodiments are not intended to be limited to this specific terminology. It is to be understood that each specific portion includes all technical equivalents that operate in a similar manner to accomplish a similar purpose.

Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures.

The present invention relates to a system for managing data within a multi-cloud environment and ingesting data from various data-sources, users, applications, custom scripts, and the like within a single central repository. The present system is further adapted to support various stakeholders and users by visualizing various insights, security risks, usage pattern, custom scripting access history, security breaches, resource managements, decision support analysis and the like onto an output screen, in accordance with roles and responsibilities or access privileges of the users. The system is provided with a computing unit adapted to provide an input query from a subject user. In an embodiment of the present invention, the apparatus may be used as a web-based service. However, in other embodiments, the system may be provided in the form of an automated alert service. In yet another embodiment of the present invention, the system may be used by stakeholders such as administrator teams, security team, security engineers, top-level leadership, infrastructure engineers and the like in providing relevant information/insights/updates thereto. It is to be understood that unless otherwise indicated, the present invention need not be limited to applications related to determination of access management and/or security management. As one of ordinary skill in the art would appreciate, variations of the invention may be applied to any kind of user for any other possible insights, usage history pattern, specific user's data search, specific data search, and the like. Moreover, it should be understood that embodiments of the present invention may be applied in combination with various other data sources, such as SAAS tools, in-house software, and any other known platforms. It must also be noted that, as used in this specification and the appended claims, the singular forms “a,” “an” and “the” include plural referents unless the context clearly dictates otherwise. Thus, for example, the term “a query” is intended to mean a single query or a combination of queries. Similarly, “an algorithm” is intended to mean one or more algorithms for the same purpose, or a combination of algorithms for performing different program executions.

Accordingly, the present invention provides a system for performing data-management in a multi-cloud environment. The system comprises a computing unit connected to a plurality of cloud servers, the computing unit further comprising an application interface adapted to present at least one input query. The system further comprises a central controller comprising: a data ingesting module adapted to receive a resource data-set from a plurality of data sources and subsequently store within a central repository, the plurality of data-sources comprising at least one cloud server; an app controller module adapted to integrate one or more applications within the central controller, each application of the one or more applications being individually connected with the central repository so as to enable an access to the resource data sets, the app controller module further adapted to store an application data-sct pertaining to tasks, results and insights of the one or more applications; a security controller module adapted to detect, capture and recognize the tasks and/or data accessed by each of the one or more applications and/or users, and store in the form of a security data-set within the central repository; and a data management module adapted to collect, for each of a user of the multi-cloud environment, a complete data-set including the resource data-set, the application data-set and the security dataset, the data management module further adapted to process the complete data-set in accordance with the input query received at the central controller and to subsequently visualize an output onto the application interface of the computing unit.

In an embodiment, the data management module comprises a resource manager module for accessing and/or querying the resource data-sets received by the data-ingesting module.

In another embodiment, the data management module comprises an application manager module for accessing and/or querying the application data-sets related to the one or more applications managed by the app controller module.

In yet another embodiment, the data management module comprises a security manager module for accessing and/or querying the security data-sets security controller module.

In yet another embodiment, the plurality of data-sources comprises one or more cloud servers selected from one or more of Azure, GCP, AWS, and the like and/or one or more SAAS.

In yet another embodiment, the application interface is adapted to send the input query to the central controller via one or more first communication medium.

In yet another embodiment, the first communication medium is selected in the form of an application programming interface (API) connecting the application interface with the central controller.

In yet another embodiment, the resource data-set comprises application data, subscription data, user projects, user access data, and various kind of data positioned and/or stored onto the one or more data sources of the multi-cloud environment.

In yet another embodiment, the central controller further comprises a graph db module adapted to create one or more graphical dashboard-based visualizations of the identity and access management data in the multi-cloud environment. The graph db module is further adapted to store various network connections within the VPC and is configured to provide visualization of the network topology. Moreover, the graph db module is adapted to visualize firewall rules and connectivity within all the network components.

In yet another embodiment, the security controller comprises a snapshot capturing submodule, a scanning sub-module and a data collection submodule.

A method for managing data in a multi-cloud environment is also provided herein in which the multi-cloud environment comprises a central controller having a central repository, connected to a plurality of cloud servers via a communication medium. The method comprises the steps of receiving, on an application interface, on a first computing unit, at least one input query related to one or more applications/users/instances within the multi-cloud environment; sending the input query from the application interface to the central controller; processing at the central controller, the input query in accordance with one or more processing modules, causing a processing unit of the central controller to: collect and identify a complete data-set for each of the users/applications of the multi-cloud environment, the collection comprising at least a security data identified by detecting, capturing and recognizing the tasks and/or data accessed by plurality of users and/or applications and/or resources of the multi-cloud environment; and graphically visualize the identified data-set, in accordance with the input query, onto an output component of the application interface.

In an embodiment, the method further comprises ingestion of an information data-set from a plurality of data sources and subsequently storing within a central repository, the plurality of data-sources comprising at least one cloud server.

In another embodiment, the method further comprises integrating one or more applications within the central controller, wherein further an application data-set pertaining to tasks, results and insights of the one or more applications are stored within the central repository.

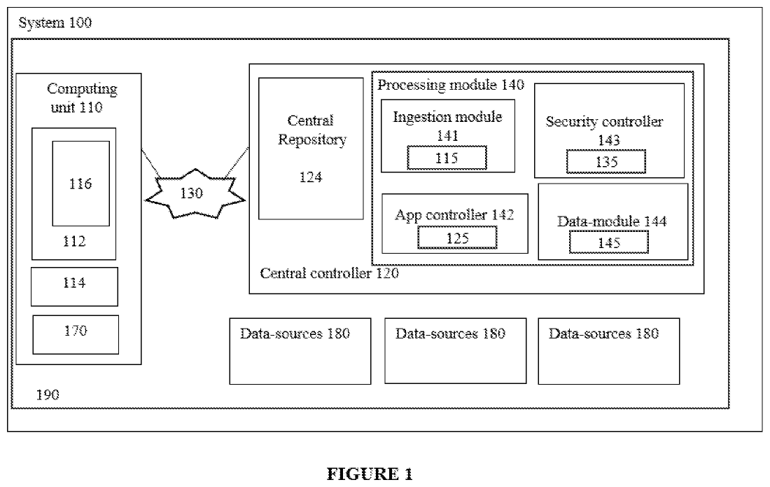

In description of the FIGS. 1 to 4 that follow, elements common to the schematic system will have the same number designation unless otherwise noted. In a first embodiment, as illustrated in FIG. 1, the present subject matter provides a system 100 for managing data within a multi-cloud environment in accordance with some embodiments. As illustrated in FIG. 1, the system 100 includes a computing device 110 connected to a central controller 120 through a communication medium 130. While the system 100 in FIG. 1 illustrates only one computing unit 110, it is contemplated for a person skilled in the art that the system environment can have any number of computer computing units 110. Similarly, multiple systems 100 may be connected to each other.

In an embodiment, the computing unit 110 includes an input/output module 112 having an application interface 116 adapted to present at least one query based at least in part generally related to one or more applications/users/instances within a multi-cloud environment 190. The application interface 116 may also formulate the at least one query. The input/output module 112 is further configured to elicit a response to the at least one query from the central controller 120. The computing unit 110 can be personal or mobile computing devices, such as smartphone, tablets, or notebook computers. In some embodiments, the computing unit 110 may include an executable client application that uses an application programming interface (API) to communicate with the central controller 120 through the communication medium 130. One or more queries may include questions related to various events and/or patterns within the multi-cloud environment, for example, historical asset utilization information, access information of various resources, security breach history, IP search/email address search functionality for searching for any IP address/email address within the entire infrastructure, spanning backdated timestamps across multiple accounts, clouds, platforms, audit trail of user activities and access privileges, accessing historical IAM data and usage patterns, and the like, in addition to any question that may be considered an important factor in facilitating data insights, decision-making, and enabling organizations to promptly address security concerns within the multi-cloud environment.

The computing unit 110 further includes one or more communication interfaces 114 adapted to enable communication thereof with other stake holders, such as service engineers, infrastructure engineers, top level executives, administrator teams, and the like, to whom an alert may be sent and/or to communicatively connect the computing device 110 to the central controller 120 through the communication medium 130. In a preferred embodiment, the communication interface 114 is a high energy communication interface, generally in the form of a Wi-Fi interface adapted to communicate with the central controller 120 through the communication medium 130, generally in the form a network selected from one or more of but not limited to a WAN, Internet, Intranet, and the like. However, in other embodiments, the communication interface 114 may be in the form of a wired interface such as LAN, and the like.

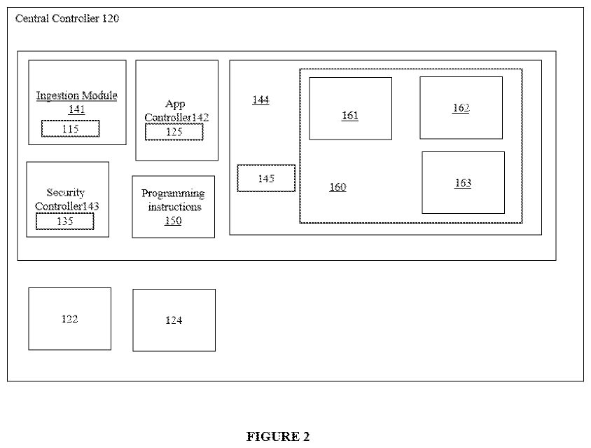

In an embodiment, the central controller 120 is a backend server in the form of a computing unit having one or more data-receiving components 122 and a central data repository 124 adapted to receive the data from a variety of data-sources, applications and other users within the multi-cloud environment, as shown in FIG. 2. Examples of such data-sources include cloud environments such as AWS, Azure, GCP and multiple SaaS platforms that are part of the multi-cloud environment 190.

FIG. 2 represents a high-level block diagram of a central controller in accordance with an exemplary embodiment of the present subject matter. In an embodiment, as shown in FIGS. 1 and 2, the central controller 120 includes one or more processing modules 140, each comprising a set of programming instructions 150 generally based on one or more deep learning model and configured to perform a predetermined activity.

The processing module 140 includes a data ingesting module 141 adapted to receive a resource data-set 115 from a plurality of data-sources 180 and/or store in the central repository 124. The resource data-sets 115 pertain to data related to users and/or application and/or event, from one or more data sources, such as, one or more cloud servers of the application databases, user information, access rights, user access history, resource usage history, application interconnection, application resource access, and the like.

In an embodiment, the processing module 140 further includes an application controller module 142 adapted to integrate one or more applications within the central controller 120 and to facilitate seamless access and querying the resource data-sets 115 stored within the central repository 124. The application controller module 142 is adapted to store an application data-set 125 pertaining to tasks, results and insights of the one or more applications [not shown] within the central repository 124. In an embodiment, the application data sets 125, within the described system 100, cover a broad spectrum of information, including task details, outcomes, insights, resource utilization patterns, application configurations, security-related activities, performance metrics, user interactions, error logs, and compliance-related data of the applications managed by the application controller module 142. Such data-sets 125 capture the multifaceted aspects of each application's performance within the multi-cloud environment. For instance, task data outlines specific activities executed by applications, result data showcases outcomes and metrics, and insight data provides actionable interpretations. Additionally, resource utilization data monitors how applications utilize resources, and security-related data logs authentication events and security measures. Performance metrics offer insights into responsiveness and efficiency, user interaction data captures input and feedback, error logs document encountered issues, error events queried from logs stored externally, and compliance data ensures adherence to regulatory standards. This comprehensive collection of application data sets empowers the system with the ability to analyze, visualize, and derive meaningful insights for informed decision-making across the multi-cloud environment.

The processing module 140 further includes a security controller module 143 adapted to detect, capture and recognize the tasks and/or data accessed by each of the one or more applications and/or users and to store the same in the form of a security data-set 135 within the central repository 124. The security data-set 135 acts as a comprehensive record, documenting the intricacies of tasks performed and data accessed, providing a detailed account of user and application interactions. By centralizing this security data-set 135, the central controller 120 enhances its ability to monitor and analyze potential security threats, thereby ensuring a proactive approach to cybersecurity within the multi-cloud environment 190.

The processing module 140 further includes a data management module 144 that is configured to gather a complete data-set 145 for each user within the multi-cloud environment 190. The complete data-set 145 encompasses the resource data-set 115, the application data-set 125, and the security data-set 135, providing a holistic view of user activities and interactions within the system 100. In a preferred embodiment, the data management module 144 includes a plurality of sub-modules 160 for efficiently accessing individual data sets, namely the resource data-sets 115, the application data-sets 125, and the security data-sets 135, through its specialized sub-modules 160. In an embodiment, the submodule 160 includes a resource manager sub-module 161 adapted to facilitate access to and management of resource data-sets 115, ensuring streamlined handling of information related to cloud servers, usage history, and interconnections. In an embodiment, the sub-module 160 also includes an application manager sub-module 162 adapted to handles the integration and querying of application data-sets 125, capturing tasks, results, and insights generated by various applications within the central controller 120. Furthermore, in an embodiment, the submodule 160 includes a security data manager sub-module 163 dedicated to access and manage security data-sets 135, which include records of tasks, data access, and security incidents. This modular approach enhances the efficiency of the data management module, enabling focused and specialized handling of diverse data sets for a user-centric, multi-cloud environment 190.

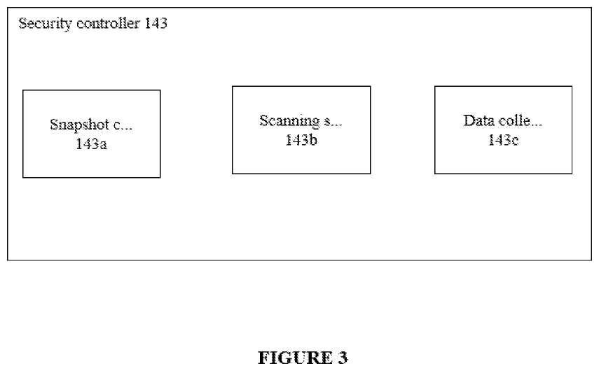

FIG. 3 illustrates a block diagram of the security controller 143 according to an embodiments of the present disclosure. In some embodiments, the security controller 143 may include a snapshot capturing submodule 143a, a scanning sub-module 143b, and a data collection submodule 143c.

The data-management module 144 is configured to process the received data sets 115, 125, 135, and 145, in accordance with one or more programming instructions 150 in accordance with the input query. The central data repository 124 includes the data sets 115, 125, 135, and 145, which are constantly upgraded on the basis of one or more learning models selected from but not limited to Natural language processing (NLP), Deep Learning, Machine Learning, statistical learning model, and the like.

The set of programming instructions 150 are generally based on one or more deep learning models and/or rule based engines and/or Machine Learning models and is configured to cause the central controller 120 and/or the processing modules 140 to process the input query on the basis the data-sets stored within the central repository 124. In an embodiment of the present invention, the system 100 including the programming instructions 150 and the implementation to process the input query are based on a deep learning model wherein the model is particularly applied to upgrade the data repository 124 including each of the data sets 115, 125, 135 and 145. Particularly, the deep learning model includes a number of pre-processing steps that are applied on the data stored in all the individual data sets 115, 125, 135 and 145. The pre-processing steps may include cleansing the data to remove any inconsistencies and assigning weights to each of the parameters for the consideration of assessments. Particularly, a list of parameters/features may be determined at this step.

Further, the machine learning model and/or the deep learning model includes a learning engine adapted to run a selected model (e.g., deep learning model, random forest, multi linear regression, multilayered, feed-forward neural networks, statistical model or the like) on the data sets 115, 125, 135 and 145 and partitions them into either a training dataset or a testing dataset. In a preferred embodiment, the partitioning may apply an 80/20 split between the training dataset and the testing dataset, respectively.

Thereafter, the learning engine operates to then run the selected model on the training dataset to obtain a resulting output from the model. For example, in a preferred embodiment, the selected model is the multilayered, feed-forward neural network, with a Tensor flow backend to build and train the neural networks.

The learning engine then selects and tunes other model arguments of the training dataset to establish an error percentage. Once the error percentage (i.e., accuracy) is established, the learning engine applies a ten-fold cross validation to establish a model stability of the selected model. Further, the learning engine operates dynamically by dynamically selecting the model arguments for each run of the selected model.

Further, the learning engine operates a final model run on the testing dataset to confirm that the accuracy and/or fit of the selected model are within client acceptable limits. When the accuracy and/or fit of the selected model is not within the client acceptable limits or when there are more models left for consideration, a next model may be selected to begin the testing process over again. When the accuracy and/or fit of the selected model is determined to be within the client acceptable limits or when there are no more models left for consideration, selected model is established for use to process the input query and provide an output to one or more subject users of the computing unit 110.

In an embodiment, the system 100 additionally includes a visualization component 170 configured as a GUI adapted to visualize the output of the input query on a unified dashboard or in any other graphically suitable way in accordance with the kind of output. In a preferred embodiment, the time-line scale is a graphical interface designed in the form of daily, monthly, yearly segments, each segment adapted to visually usage patterns, predicted risks, or any other insights during the segmented time period.

The functions performed by various entities of FIG. 1 may vary in different embodiments. For example, in some embodiments, the computing unit 110 is operated by the subject user itself, to get an insight/information in accordance with its job responsibilities. However, in other embodiments, the central controller 120 may be adapted to provide automated reports/alerts, as they may arise to the subject user onto the application interface 116. Similarly in some other embodiments, the computer unit 110 may be embodied with additional input/output components which may be contemplated by a person skilled in the art without deviating from the scope of current disclosure.

Although illustrated and described herein as computing unit 110, it is to be understood that embodiments of the invention could be implemented with any kind of computing devices, such as a laptop computer, smartphone or the like.

As illustrated, the central controller 120 is programmed to implement different methods of the disclosure. In an embodiment, the central controller 120 is programmed or otherwise configured to assess the input query related to data management within the multi-cloud environment 190, in a single session or over multiple different sessions through the computing unit 110.

FIGS. 1 and 2 schematically show the arrangement of the basic components of the system of the present subject matter. However, in the construction of automated tools, secondary components such as different memories, databases, clouds, network and other related functional components known to one of skilled in the field of automated tools based on deep leaning methodologies, may be incorporated in the system. Such functional and/or supporting components are included in the present invention as long as the logical components and arrangements disclosed herein are present.

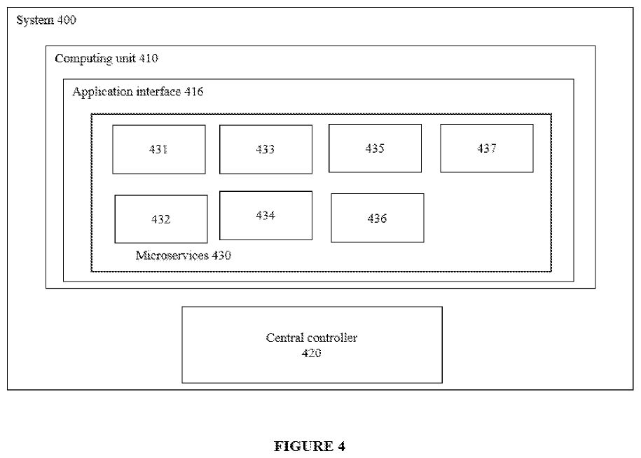

In an embodiment, as illustrated in FIG. 4, the system 400 is disclosed, wherein the central controller 420 of the current disclosure may be provided in the form of a microservice based architecture. In such an embodiment, the central controller 420 may include a core component and a plurality of microservices, each microservice/component may utilize one or more processing modules of the central controller 420. For example, as illustrated, the core component 420 serves as the core engine of the application, managing and processing data. It takes on crucial tasks such as data collection, security scans, and vulnerability analysis. The module included within this component may include all the processing modules including data-ingesting module, the application controller module, the data-management module, and the security controller module.

The microservices may include a User Access Management microservice 431 dedicated to managing user access to the application. The User Access Management microservice is generally adapted to define and enforce user roles and access privileges to safeguard sensitive data and regulate cybersecurity tasks. Accordingly, the User Access Management microservice may be utilized to enhance security by restricting access to authorized individuals, preventing unauthorized users from compromising sensitive information.

The microservices may further include a Multi-Cloud Security Governance microservice 432 adapted to support multi-cloud environments, allowing users to oversee and govern security practices across diverse cloud platforms such as Azure, GCP, AWS, and more. Such a microservice may ensure that consistent security measures are applied across different cloud providers, promoting a unified approach to cybersecurity in multi-cloud scenarios.

The microservices may furthermore include a Third-Party App Management Microservice 433 adapted to provide a secure framework for managing third-party applications. This includes monitoring, controlling access, ensuring adherence to security standards, and mitigating potential risks associated with these applications. Such a microservice facilitates integration of various third-party applications while ensuring that security practices extend beyond the core platform to encompass all integrated applications.

In some embodiments, the microservices may further include a Custom Scripting microservice 434 adapted to allow users to create and execute custom scripts within the multi-cloud environments. Such a microservice offers flexibility in performing specific cybersecurity tasks or automating processes tailored to the organization's unique requirements.

In some embodiments, the microservices may further include a security scan microservice 435 adapted to perform a user triggered and/or a scheduled triggered based scan of the multi-cloud environment, encompassing all components and resources across multiple cloud environments, including AWS, Azure, GCP, and other integrated platforms. For example, in some embodiments, the security scan process can be initiated manually by a user or in some other embodiments, the security scan may be scheduled to run at predefined intervals. In yet other embodiments, the security scan may be triggered by occurrence of certain predefined events such as system updates or configuration changes, and the like.

In some embodiments, the central controller may be integrated with an automated remediation microservice 436 that can address identified vulnerabilities or misconfigurations without manual intervention, enhancing the efficiency of the cybersecurity workflow.

The plurality of microservices, in addition to the above disclosed microservices, may include a Reporting and Alerting microservice 437 adapted to generate real-time alerts for identified vulnerabilities or security breaches. These alerts are promptly communicated to predefine users such as, security team, ensuring quick response and mitigation. Further, such a microservice facilitates reporting of the results of the security scan, along with detailed reports, through the application interface. Users can access comprehensive insights into the security posture of their multi-cloud environment, enabling informed decision-making.

In another embodiment, the plurality of microservices may include any custom created micro-service that may be utilized to facilitate a seamless utilization, real-time insight, actionable information, and the ability to maintain a consistent and secure posture across the multi-cloud environment.

In a preferred embodiment, the microservices 430 are presented to users onto the application interface 416 in the form of a unified dashboard. Particularly, the interface, in such embodiments, may serve as a command center for analyzing vulnerabilities, managing resources, and orchestrating cybersecurity efforts across various dimensions. The user interface is designed to be intuitive, allowing users to navigate and interact with the platform seamlessly, contributing to a more effective and efficient cybersecurity management experience. The central core 420 is invisible to the user and works as a back-end entity for processing the instructions received via the microservices.

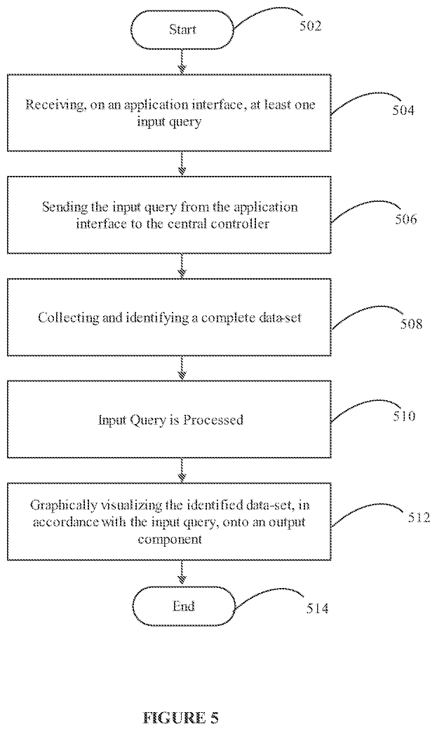

FIG. 5 is a flowchart that describes a method 500 for managing data in a multi-cloud environment 190, according to an embodiment of the present disclosure. The method 500 starts at step 502 and proceeds to step 504 where an input request is received on an application interface, on a first computing unit 110. The at least one input query is generally related to one or more applications/users/instances within the multi-cloud environment 190. In some embodiments, the input query may be related to summary of resources within the multi-cloud environment. In some other embodiments, the query may be related to application summary and resource history. In yet other embodiments, the input query may be access and security related queries within the multi-cloud environment. Examples of the input query include but are not limited to historical asset utilization information, access information of various resources, IP search/email address search functionality for searching for any IP address/email address within the entire infrastructure, spanning backdated timestamps across multiple accounts, clouds, platforms, audit trail of user activities and access privileges, accessing historical IAM data and usage patterns, and the like, thereby facilitating data insights, decision-making, and enabling organizations to promptly address security concerns within the multi-cloud environment.

The method 500 then proceeds to step 506 where the input query from the application interface is sent to the central controller 120 via the communication medium 130. In some embodiments, the computing unit 110 may include an executable client application that uses an application programming interface (API) to communicate with the central repository 124 through the communication medium 130.

At step 508, the method 500 proceeds to the step of collecting and identifying a complete data-set 145 for each of the users/applications of the multi-cloud environment. Particularly, at this step, a complete data set 145 is collated within the central repository 124. Such complete data-set includes resource data-set 115 received from the plurality of cloud servers and/or various other data sources which are ingested by the data ingesting module 141 and stored in the central repository 124. An example of such data-sources includes cloud environments such as AWS, Azure, and multiple SaaS platforms currently known in the art.

Further, the complete data-set 145 includes application data-set 125 pertaining to resources utilized, tasks performed, results and insights of the one or more applications, stored by the application controller module 142 within the central repository 124. Furthermore, the complete data-set 145 includes the security data-set 135 obtained by detecting, capturing and recognizing the tasks and/or data accessed by each of the one or more applications and/or users and then stored within the central repository 124. In a preferred embodiment, the complete data-sets including resource data-sets, the application data-sets, and the security data-sets are accessed by the data-management module 160 using its sub-module namely, the resource manager module 161, the application manager module 162 and the security data manager module 163 respectively.

In a preferred embodiment, the complete data set including the ingested resource data set, the application data-set and the security data-set is stored in the form of a standardized format, preferably as JSON data-format, thereby enabling an easy integration and analysis of the data-sets.

The method then proceeds to step 510 where the input query is processed in accordance with one or more programming instructions 150 and in using the complete data-sets to identify an output data-set which is then graphically visualized onto an output component of the application interface 116 at step 512. The method 500 terminates at step 514.

Accordingly, the system 100 may be used for facilitating seamless integration of various resources and components within a multi-cloud environment. Particularly, the system provides a centralized architecture in the form of core entity which manages all integrations and data storage within the central repository, an app controller module for managing all the applications within the multi-cloud environment, and a security controller module focusing on capturing and storing the current state of resources along with their associated metadata. Such a metadata of resource management for associated cloud servers, and SaaS tools, allows users to access historical asset snapshots of resources from specific dates in the past. This feature empowers users with valuable insights into the state of their assets at any given moment, enhancing their ability to manage and analyze resource data effectively.

The system's app connecting module allows seamless integration with various applications and tools. This enables organizations to leverage existing security solutions, automation scripts, and analytics platforms, enhancing the overall security posture of the multi-cloud environment. In some embodiments, the app controller module may allow users to submit their custom code as “jobs” that utilize central repository's resources including APIs and may run in an isolated environment. Moreover, in such embodiments, the output of such jobs is stored and sent back to the central repository. This approach enables a possibility of standardizing all the jobs and also facilitates self-service operations, which may also be monitored and tracked in real time as well as at any point of time in future.

Further, the system 100 may be used to determine an access management strategy using deep learning methodologies to secure access of the plurality of resources stored and/or positioned onto the multi-cloud environment.

Through the collection and visualization of identity and access management data, the present invention enables organizations to gain a holistic view of user activities and resource usage. This fosters greater user accountability, as administrators can trace actions back to individual users, applications, or resources, enhancing transparency and reducing the likelihood of insider threats. Moreover, the resource management module streamlines the process of querying and retrieving data sets from the central repository. This improves resource allocation and utilization across cloud servers, optimizing overall operational efficiency and cost-effectiveness.

The system of the current disclosure also facilitates a single source of input data sets from various cloud servers. This centralized approach simplifies data storage, retrieval, and analysis, enabling organizations to make informed decisions based on accurate and up-to-date information. Moreover, such a system facilitates a comprehensive audit trail of user activities and access privileges. Organizations can easily demonstrate compliance with regulatory standards, such as GDPR or HIPAA, by accessing historical IAM data and usage patterns. Moreover, the system's ability to visualize identity and access management data through a user interface allows organizations to tailor reports and dashboards according to their specific needs. This customization enhances data insights, facilitates decision-making, and enables organizations to promptly address security concerns.

The architecture of the present invention is designed to accommodate the dynamic nature of multi-cloud environments. It can easily scale horizontally to handle increasing amounts of data and resources, ensuring that security and access management remain effective as the organization's needs evolve. Accordingly, it may also be understood that the disclosed system and method for data management in a multi-cloud environment offers a range of advantages that address the complex challenges associated with security, identity, and access management in multi-cloud environments. This system revolutionizes the way organizations safeguard their data, applications, and resources, ensuring enhanced security, operational efficiency, and regulatory compliance. Particularly, the system of the current disclosure provides a unified and adaptable framework for managing security across diverse cloud service providers, such as Azure, GCP, AWS, and more. This eliminates the need for organizations to implement separate security measures for each cloud platform, ensuring consistent protection and reducing complexity. Additionally, by seamlessly integrating with various cloud platforms, the present invention facilitates consistent IAM policies and access control mechanisms thereby allowing the organizations to define and enforce access privileges, user roles, and authentication mechanisms across their entire multi-cloud environment, simplifying user management and reducing the risk of unauthorized access. The system of the current disclosure offers real-time monitoring, detection, and analysis of tasks and data accessed by applications and resources. This proactive approach allows organizations to identify security breaches, anomalies, and potential threats as they occur, enabling timely mitigation actions in a real time.

### Use Cases as Per Job Role:

Security Engineers: The present invention provides security engineers with all the security scan results, enabling them to take necessary actions. With just a few clicks, they can quickly and accurately search the data and obtain precise details about specific findings, and security vulnerabilities.
Infrastructure Engineers: The present invention offers a unified search functionality that operates across multiple cloud providers. This feature saves time by swiftly locating particular resources, also verifying if a resource existed previously using the historic data.
Security Team: The present invention also assists the security team in providing evidence for compliance-related tasks.
Top-level Leadership: Based on the gathered data, the team can create dashboards with a clutter-free interface for identifying pending issues.

Accordingly, the present invention represents a paradigm shift in multi-cloud security by offering a comprehensive system and method for data/resource management within a multi-cloud environment. Its ability to provide unified security measures, real-time monitoring, and detailed visualization empowers organizations to confidently embrace multi-cloud computing while effectively safeguarding their assets, ensuring compliance, and optimizing operational efficiency.

The present system in some embodiments, may be provided in the form of a computer readable storage medium, which can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to individualize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention enable a learning apparatus learning a model corresponding to time-series input data to have higher expressive ability and learning ability and to perform the learning operation more simply.

We claim:

1. A system for performing data-management in a multi-cloud environment, the system comprising:
a computing unit connected to a plurality of cloud servers, the computing unit comprising an application interface adapted to present at least one input query;
a central controller comprising:
a data ingesting module adapted to receive a resource data-set from a plurality of data sources and subsequently store within a central repository, the plurality of data-sources comprising at least one cloud server;
an app controller module adapted to integrate one or more applications within the central controller, each application of the one or more applications being individually connected with the central repository to enable access to the resource data-set, the app controller module further adapted to store an application data-set pertaining to tasks, results and insights of the one or more applications;
a security controller module adapted to detect, capture and recognize at least one of the tasks or the data accessed by each of the one or more applications or users, and store in a form of a security data-set within the central repository; and
a data management module adapted to collect, for each of the users, a complete data-set including the resource data-set, the application data-set and the security data-set, the data management module further adapted to process the complete data-set in accordance with the at least one input query received at the central controller and to subsequently visualize an output onto the application interface of the computing unit.

2. The system of claim 1, wherein the data management module comprises a resource manager module for accessing the resource data-set received by the data-ingesting module.

3. The system of claim 1, wherein the data management module comprises an application manager module for accessing the application data-set related to the one or more applications managed by the app controller module.

4. The system of claim 1, wherein the data management module comprises a security manager module for accessing the security data-set stored by the security controller module.

5. The system of claim 1, wherein the plurality of data-sources comprises one or more cloud servers or one or more SaaS.

6. The system of claim 1, wherein the application interface is adapted to send the at least one input query to the central controller via one or more first communication mediums.

7. The system of claim 6, wherein the one or more first communication mediums is selected in the form of an application programming interface (API) connecting the application interface with the central controller.

8. The system of claim 1, wherein the resource data-set comprises application data, subscription data, user projects, user access data, and other data positioned or stored on the one or more data sources of the multi-cloud environment.

9. The system of claim 1, wherein the central controller further comprises a graph dB module adapted to create one or more graphical dashboard-based visualizations of identity and access management data in the multi-cloud environment.

10. The system of claim 1, wherein the security controller comprises a snapshot capturing submodule, a scanning sub-module and a data collection submodule.

11. A method for managing data in a multi-cloud environment, the multi-cloud environment comprising a central controller having a central repository, connected to a plurality of cloud servers via a communication medium, the method comprising the steps of:
receiving, on an application interface, on a first computing unit, at least one input query related to one or more applications, users, or instances within the multi-cloud environment;
sending the at least one input query from the application interface to the central controller;
processing at the central controller, the at least one input query in accordance with one or more processing modules, causing a processing unit of the central controller to:
collect and identify a complete data-set for each of the users or the one or more applications of the multi-cloud environment, the collection comprising at least a security data identified by detecting, capturing and recognizing the tasks or data accessed by the one or more applications, users, or instances of the multi-cloud environment; and
graphically visualize the complete identified data-set, in accordance with the at least one input query, on an output component of the application interface.

12. The method of claim 11, further comprising ingesting an information data-set from a plurality of data sources and subsequently storing the information data-set within a central repository, the plurality of data-sources comprising at least one cloud server.

13. The method of claim 11, further comprising integrating one or more applications within the central controller, wherein further an application data-set pertaining to tasks, results and insights of the one or more applications are stored within the central repository.
